(19) United States
(12) Patent Application Publication
(10) Pub. No.: US 2019/0062054 A1
(43) Pub. Date: Feb. 28, 2019

(54) Automated Routing Systems and Methods

(71) Applicant: Walmart Apollo, LLC, Bentonville, AR (US)

(72) Inventors: Behzad Nemati, Springdale, AR (US); Ehsan Nazarian, Rogers, AR (US)

(21) Appl. No.: 16/113,782

(22) Filed: Aug. 27, 2018

Related U.S. Application Data
(60) Provisional application No. 62/551,060, filed on Aug. 28, 2017.

(51) Int. Cl. B65G 1/137; G05B 15/02

(52) U.S. Cl. CPC B65G 1/1371; G05B 15/02

(57) ABSTRACT

Described in detail herein are automated routing systems and methods. A first conveyer belt system can receive and transport storage containers. A label including an object machine-readable element encoded with an object identifier is disposed on each of the storage containers. The conveyer carousel system coupled to the first conveyer belt system can receive the storage containers from the first conveyer belt system. A diverter can guide the storage containers to remain on the conveyer carousel system or route each storage container one of a geographically distributed kiosks external to the facility. The geographically distributed kiosk can receive an identifier associated with the label of a specified one of the storage containers can control the diverter to route the specified one of the storage containers from the conveyer carousel system to the geographically distributed kiosks in response to receipt of the identifier.

### CROSS-REFERENCE TO RELATED PATENT APPLICATION

This application claims priority to U.S. Provisional Application: 62/551,060 filed on Aug. 28, 2017, the content of which is hereby incorporated by reference in its entirety.

### BACKGROUND

It can be difficult to manually route storage containers to an accurate location.

### BRIEF DESCRIPTION OF DRAWINGS

Illustrative embodiments are shown by way of example in the accompanying drawings and should not be considered as a limitation of the present disclosure:

FIG. 1 is a block diagram of a mobile device that can be utilized to implement and/or interact with embodiments of an automated routing system;

FIG. 2 illustrates a terminal disposed in a facility in accordance with an exemplary embodiment;

FIG. 3A illustrates a network of conveyer belt systems in accordance with an exemplary embodiment;

FIG. 3B illustrates the network of conveyer belt systems and kiosks in accordance with an exemplary embodiment;

FIG. 3C is a block diagram of the terminals 200, conveyer belt network 300 and kiosks 320 in accordance with an exemplary embodiment;

FIG. 4 is a block diagram illustrating an automated routing system according to exemplary embodiments of the present disclosure;

FIG. 5 is a block diagram illustrating of an exemplary computing device in accordance with exemplary embodiments of the present disclosure;

FIG. 6 is a flowchart illustrating an exemplary process in accordance with exemplary embodiments of the present disclosure;

FIG. 7 is a flowchart illustrating an exemplary process in accordance with exemplary embodiments of the present disclosure; and

FIG. 8 is a flowchart illustrating an exemplary process in accordance with exemplary embodiments of the present disclosure.

### DETAILED DESCRIPTION

Described in detail herein are automated routing systems and methods. Exemplary embodiments can include a network of conveyor belts for routing containers from a source to a destination. For example, a first conveyer belt system can receive and transport storage containers. The first conveyer belt system can be disposed with respect to an electronic terminal in a facility. A label including an object machine-readable element encoded with an object identifier is disposed on each of the storage containers. A conveyer carousel system can be operably coupled to the first conveyer belt system and can receive the storage containers from the first conveyer belt system. The conveyer carousel system can transport the storage containers passed scanners. For example, the conveyor carousal system can include one or more conveyor loops about which the storage containers can be circulated. Diverters can guide the storage containers to remain on the conveyer carousel system, where they continue to circulate around the conveyor loops, or can route the storage containers to geographically distributed kiosks external to the facility based on the object machine-readable element on the label of each of the plurality of storage containers that is scanned by the scanner(s) as the storage containers pass by the scanners.

The geographically distributed kiosks can receive an identifier associated with the label of a specified one of the storage containers and can control the diverter(s) to route the specified one of the storage containers from the conveyer carousel system to the geographically distributed kiosks via a second conveyor belt system in response to receipt of the identifier. For example, the specified one of the storage containers can be continuously circulated about the conveyor belt system and the scanners can scan the label as the specified one of the storage containers until the identifier is scanned at one of the kiosks. After the identifier is scanned at the kiosk, the next time the scanner scans the label associated with the specified one of the storage containers, the diverter associated with the kiosk can be controlled to divert the specified one of the storage containers from the conveyor carousel system to the kiosk via another conveyor belt system. For example, the specified one of the storage container can be transported to the geographically distributed kiosk via an intermediate conveyer belt system coupled to the geographically distributed kiosk.

As another example, a mobile device can be programmed to execute an application associated with the facility, and the kiosks can be configured to receive the identifiers from the mobile device in response to the mobile device executing the application and being in geographic proximity to the kiosks for a specified amount of time.

A local computing system can be in communication the diverter(s), the scanner(s), and the geographically distributed kiosks. The scanner(s) can scan and decode the object identifier from object machine-readable elements on the labels of the one storage containers and transmit the object identifier to the local computing system. The kiosk can be configured to transmit the identifier to the local computing system. The local computing system can be configured to receive the object identifier and a retrieval identifier, determine the retrieval identifier is associated with the object identifier, and actuate the diverter to route the specified one of the plurality of storage containers to the at least one of the plurality of geographically distributed kiosks in response to determining the identifier is associated with the object identifier.

As another example, the autonomous routing system can include a terminal, including a printer that is disposed in a facility. The terminal can be configured to receive information associated with a location outside the facility, identify a kiosk from geographically distributed kiosks disposed outside the facility based on the information associated with the location. The terminal can be configured to, generate an object machine-readable element encoded with an object identifier associated with the kiosk, print a label including the object machine-readable element via the printer. The label can be placed on at least one storage container. The loading conveyer belt system can transport the at least one storage container passed a first scanner and route the at least one storage container to at least one intermediate conveyer belt system in response to the scanner scanning the object machine-readable element on the label disposed on the at least one storage container.

As another example, a kiosk of a geographically distributed kiosks are disposed outside the facility and coupled to the at least one intermediate conveyer belts. The kiosk is configured to receive an identifier associated with the label of a specified one of the plurality of storage containers and control the diverter to route the specified one of the plurality of storage containers from the conveyer carousel system to the at least one of the plurality of geographically distributed kiosks in response to receipt of the identifier. The information can include one or more of: input at the terminal, attributes of a captured image, GPS coordinates, or location information.

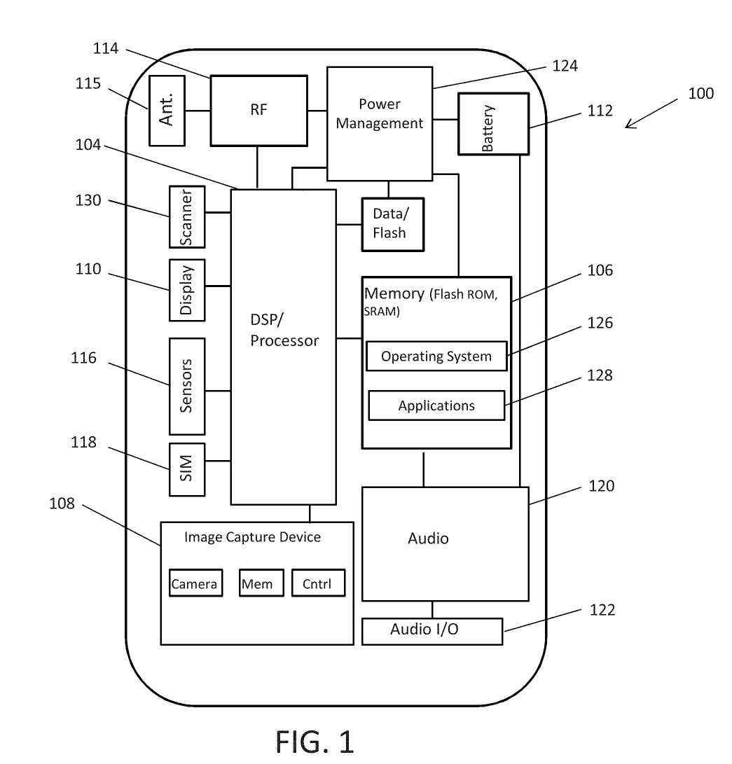

FIG. 1 is a block diagram of a mobile device that can be utilized to implement and/or interact with embodiments of an automated routing system. The mobile device 100 can be a smartphone, tablet, subnotebook, laptop, personal digital assistant (PDA), handheld device, and/or any other suitable mobile device that can be programmed and/or configured to implement and/or interact with embodiments of the system via wireless communication. The mobile device 100 can include a processing device 104, such as a digital signal processor (DSP) or microprocessor, memory/storage 106 in the form a non-transitory computer-readable medium, an image capture device 108, a touch-sensitive display 110, a power source 112, a radio frequency transceiver 114 and a reader 130. Some embodiments of the mobile device 100 can also include other common components commonly, such as sensors 116, subscriber identity module (SIM) card 118, audio input/output components 120 and 122 (including e.g., one or more microphones and one or more speakers), and power management circuitry 124.

The memory 106 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 126 and applications 128 can be embodied as computer-readable/executable program code stored on the non-transitory computer-readable memory 106 and implemented using any suitable, high or low level computing language and/or platform, such as, e.g., Java, C, C++, C#, assembly code, machine readable language, and the like. In some embodiments, the applications 128 can include a facility application, a web browser application, a mobile application specifically coded to interface with one or more servers of embodiments of the automated routing system described herein. While memory is depicted as a single component those skilled in the art will recognize that the memory can be formed from multiple components and that separate non-volatile and volatile memory devices can be used.

The processing device 104 can include any suitable single- or multiple-core microprocessor of any suitable architecture that is capable of implementing and/or facilitating an operation of the mobile device 100. For example, a user can use the mobile device 100 in a facility or outside the facility to perform an image capture operation, capture a voice input of the user (e.g., via the microphone), transmit messages including a captured image and/or a voice input and receive messages from a computing system, display data/information including GUIs of the user interface 110, captured images, voice input transcribed as text, and the like. The mobile device 100 can perform the aforementioned operations using on an internet browser executing on the mobile device, one or more application program interfaces, or any web-based application. The processing device 104 can be programmed and/or configured to execute the operating system 126 and applications 128 to implement one or more processes and/or perform one or more operations. The processing device 104 can retrieve information/data from and store information/data to the storage device 106.

The RF transceiver 114 can be configured to transmit and/or receive wireless transmissions via an antenna 115. For example, the RF transceiver 114 can be configured to transmit data/information, such as input based on user interaction with the mobile device 100. The RF transceiver 114 can be configured to transmit and/or receive data/information having at a specified frequency and/or according to a specified sequence and/or packet arrangement.

The touch-sensitive display 110 can render user interfaces, such as graphical user interfaces to a user and in some embodiments can provide a mechanism that allows the user to interact with the GUIs. For example, a user may interact with the mobile device 100 through touch-sensitive display 110, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 112 can be implemented as a battery or capacitive elements configured to store an electric charge and power the mobile device 100. In exemplary embodiments, the power source 112 can be a rechargeable power source, such as a battery or one or more capacitive elements configured to be recharged via a connection to an external power supply.

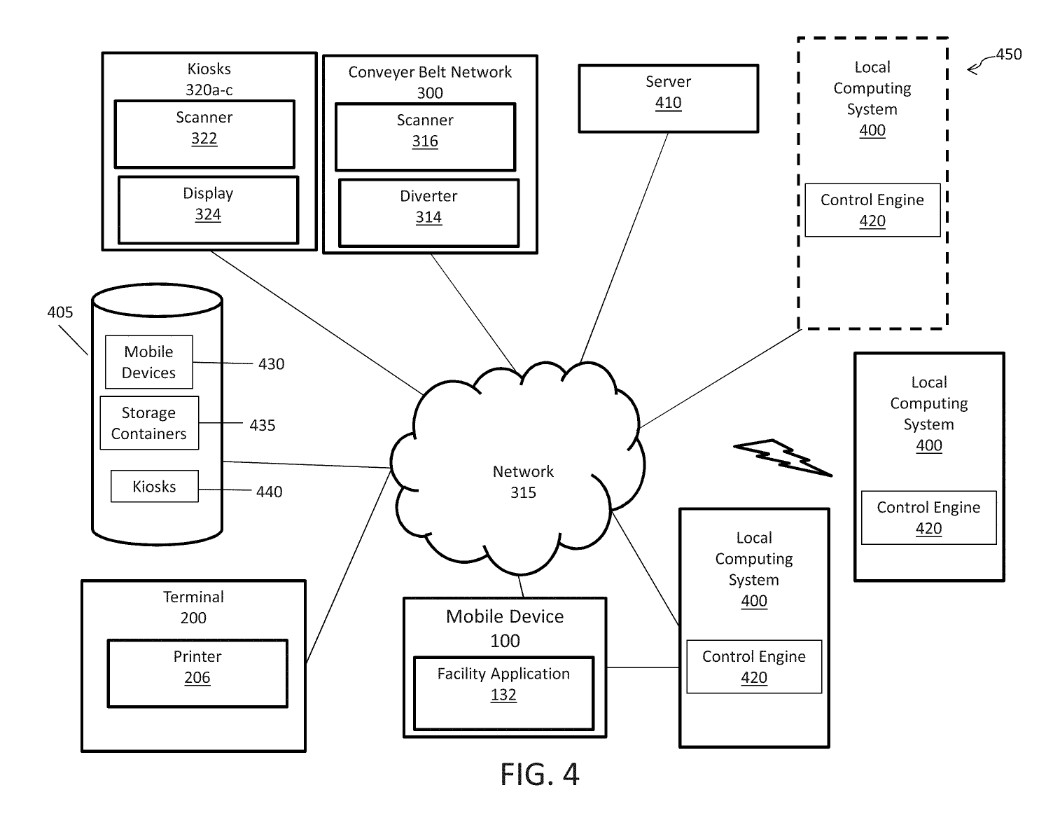

The reader 130 can be implemented as an optical reader configured to scan and decode machine-readable elements disposed on objects. The machine-readable elements can be barcodes or QR codes encoded with identifiers. The reader 130 can scan and decode the identifier from the machine-readable elements and the mobile device 100 can transmit the identifiers to a local computing system. The local computing system can transmit information associated with the identifier to the mobile device 100 can store the information in the volatile or non-volatile memory as described above. An example local computing system is described herein with respect to FIG. 4.

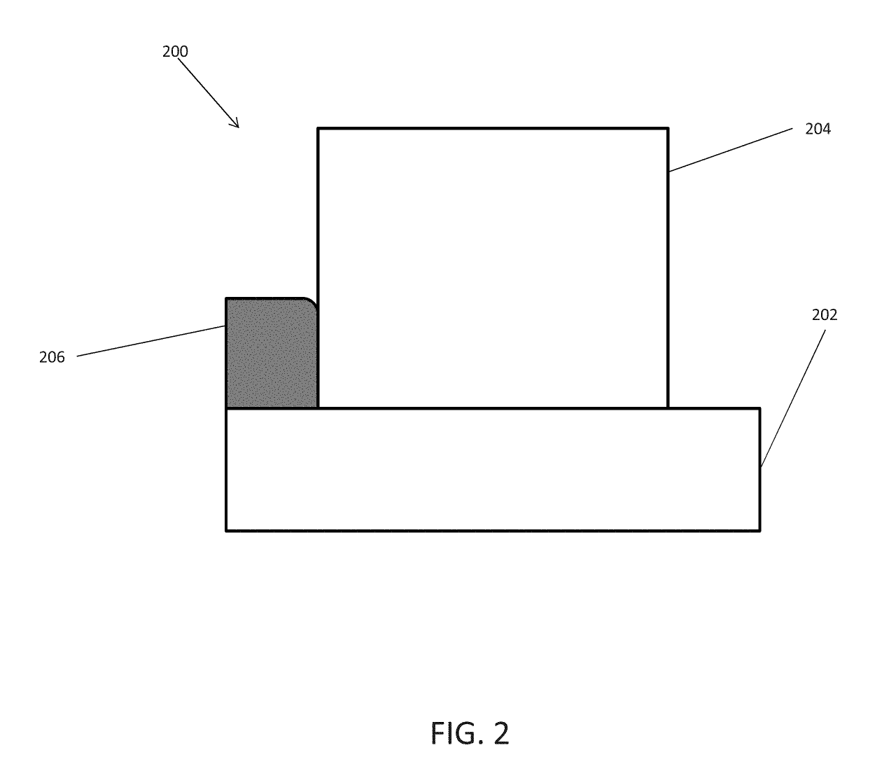

FIG. 2 illustrates a terminal disposed in a facility in accordance with an exemplary embodiment. The terminal 200 can include a processor 202, a display 204 and a printer 206. The terminal 200 can receive instructions from a local computing system, to print a label including a machine-readable element encoded with an identifier of a storage container. In some embodiments, the terminal 200 can generate the machine-readable element encoded with the identifier of the storage container. The printer 206 can print the label with the machine-readable element. The label can be affixed on a storage container.

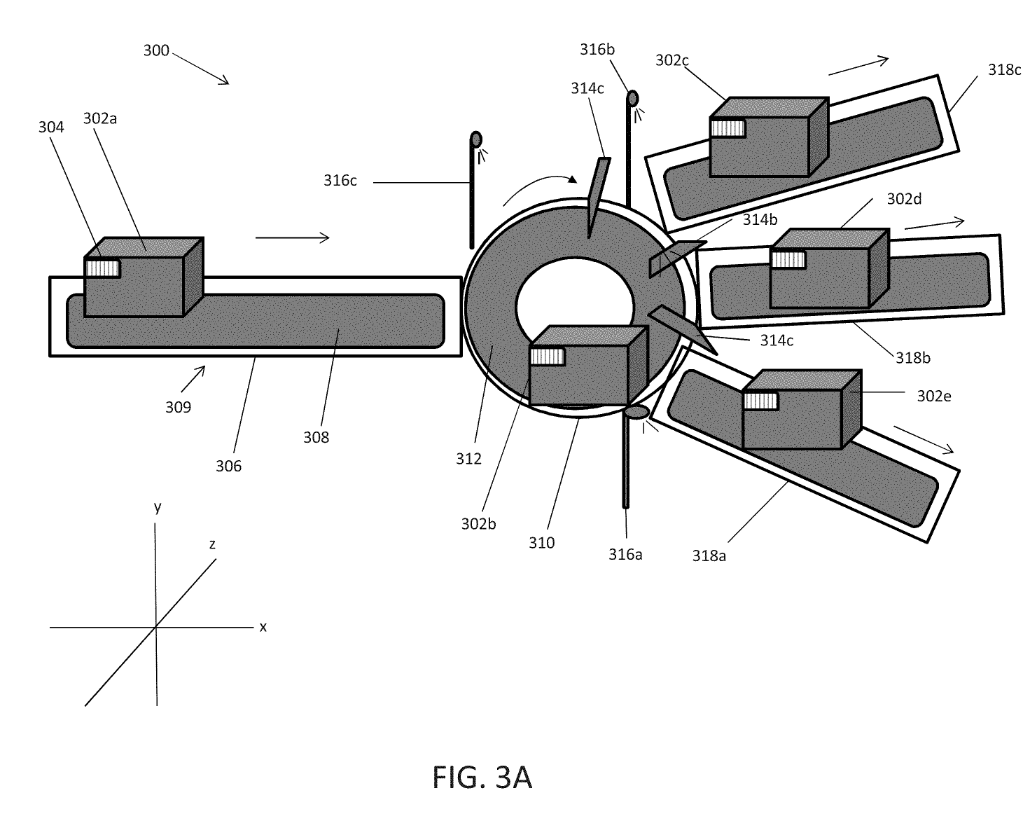

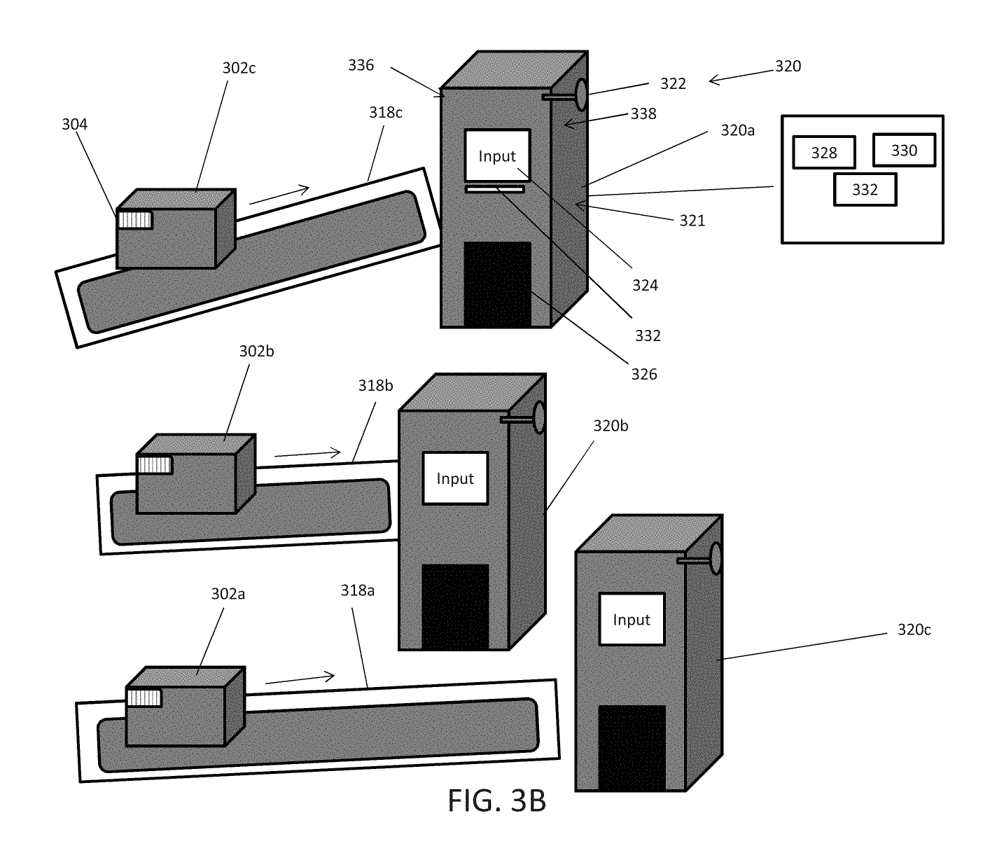

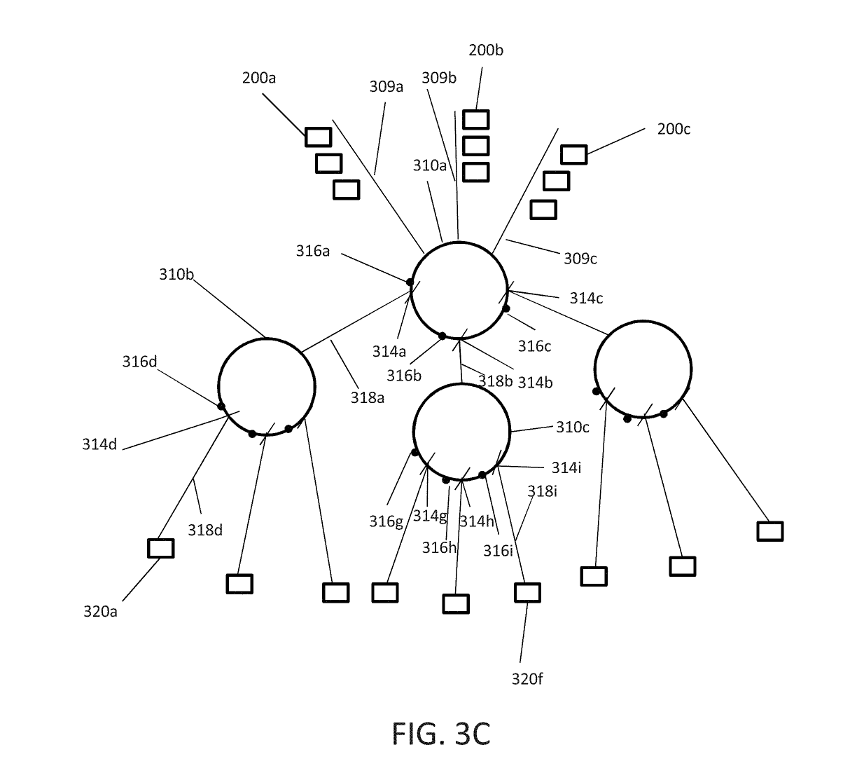

FIG. 3A illustrates a network of conveyer belt systems in accordance with an exemplary embodiment. A conveyer belt network 300 can be disposed inside and outside the facility 100. The conveyer belt network 300 can include multiple conveyer belt systems disposed above or underground. The conveyer belt systems can include a belt cabinet/frame 306 and a belt 308. The belts 308 may be conveyer/endless belts disposed on or in the belt cabinets 306, which may also include rollers (e.g., friction and drive rollers) and a drive motor. The driver motor can control one or more of the rollers (e.g., drive rollers) to rotate the belt to provide a transport for moving physical objects 302a-e from one end of the belt cabinet 306 to an opposite end of the belt cabinet 306. In some embodiments, the belt cabinets 306 can have a rectangular structure having side and bottom walls. Alternatively, the belt cabinets 306 can be other shapes such as circular, rounded rectangles, and oval. Respective ones of the belts 308 can extend along a top portion of each of the belt cabinets 306.

The conveyer belt network 300 can include a loading conveyer belt system 309, a conveyer carousel system 310 and intermediate conveyer belt systems 318a-c. Diverters 314a-c can be coupled to the conveyer carousel system 310. Each diverter 314a-c can correspond with each of the intermediate conveyer belt systems 318a-c. For example, diverter 314a can be configured to route storage containers onto intermediate conveyer belt system 318a. Diverter 314b can be configured to route storage containers onto intermediate conveyer belt system 318b. Diverter 314c can be configured to route storage containers onto intermediate conveyer belt system 318c. Optical scanners 316 a-c can be disposed with respect to the conveyer carousel system 310. Each optical scanner 316 a-c can correspond to each diverter 314a-c.

The loading conveyer belt system 309 can be disposed with respect to the terminal. The loading conveyer belt system 309 and the intermediate conveyer belt systems 318a-c can be disposed adjacent to the conveyer carousel system 310. As a non-limiting example, the loading conveyer belt system 309 can be disposed on a first proximal end of the conveyer carousel system 310 and the intermediate conveyer belt systems 318a-c can be disposed on a second distal end of the conveyer carousel system 310. The diverters 314a-c can be embodied as a mechanical arm. The diverters 314a-c can be configured to move in various angles along an x, y and z axes.

Storage containers 302a-e including physical objects from the facility can be placed and transported on the conveyer belt systems. Labels including machine-readable elements 304 can be disposed on the storage containers 302a-e. As an example, the storage container 302a can be placed on the loading conveyer belt system 309. The loading conveyer belt system 309 can transport the storage container 302a to the conveyer carousel system 310. The storage container 302a can be transferred to the belt 312 of the conveyer carousel system 310. The belt 312 can be a circular, oval, or a rounded rectangular shape.

As another example, the storage container 302b can be transferred from the loading conveyer belt 309 to the conveyer carousel system 310. The conveyer carousel system 310 can transport the storage container 302b towards the optical scanners 316a-c as the storage container travels around the conveyor carousel system. The optical scanner 316a-c can scan the machine-readable element disposed on the storage container 302b, decode an identifier associated with the storage container 302b encoded in the machine-readable element, and transmit the identifier to a central computing system. An exemplary central computing system is described in further detail with respect to FIG. 4. One of the diverters 314a-c can receive instructions to divert the storage container 302b to one of the intermediate conveyer belt systems 318a-c, based on which intermediate conveyer belt system 318a-c the storage container 302b is to be transferred. For example, the diverters 314a-c can move and/or change its position at an angle to divert the storage container 302b to a specified one of the intermediate conveyer belt systems 318a-c based on the identifier encoded in the scanned machine-readable element.

As another example, the storage containers 302c-e can be diverted from the carousel conveyer system 310 to intermediate conveyer belt systems 318a-c, respectively. The intermediate conveyer belt systems 318a-c can transport the storage containers 302c-e to kiosks in various directions as indicated by the arrows. Exemplary kiosks are described in further detail with respect to FIG. 3B.

FIG. 3B illustrates the network of conveyer belt systems and kiosks in accordance with an exemplary embodiment. The intermediate conveyer belts 318a-c can transport the storage containers 302c-e to different kiosks 320 including kiosks 320a-c. Each kiosk 320 can include a housing 321. The housing 321 can be made up of a front side 336, rear side (not shown), a right side (not shown), and a left side 338 to hold components of the kiosk 320 and to provide an interior volume for storing one or more storage containers routed to the kiosk 320. A display 324, an optical scanner 322, a processor 328, wireless receiver 330, wireless transmitter 332 and a keypad and/or pointing device 334 can be disposed within the housing 321. A front opening 326 can be disposed on the front side 336 of the housing 321. The kiosks 320 can also include a back opening (not shown) disposed on the back side of the housing 321.

The processor can control the operation of the display 324, the optical scanner 322, wireless receiver 330, wireless transmitter 332 and keypad and/or pointing device 334. The kiosk can receive input associated with retrieving a storage container 302a-c. The kiosk can receive input via, the display 324, the optical scanner 322, wireless receiver 330, wireless transceiver 332 and keypad and/or pointing device 334. For example, a user can present a machine-readable element encoded with a retrieval identifier at the optical scanner 322 to retrieve a storage container 302a-c. The optical scanner 322 can be configured to scan machine-readable elements such as barcodes or QR codes encoded with retrieval identifiers associated with the storage containers 302c-e. The display 324 can display information associated with the storage containers 302c-e. The display 324 can also receive input including identifiers associated with storage containers 302c-e. The display 324 can also render prompts, error messages and other messages associated with the storage containers 302c-e. The kiosk 320 can communicate the received input via the wireless transceiver 330.

The storage containers 302c-e can enter the kiosks 320 via, the back opening. In response to receiving instructions from a local computing system, the kiosks 320 can dispense the storage container 302c-e, via the front opening 326. The local computing system can be disposed within the facility or at a centralized location remote from the facility. It can be appreciated that the kiosks 320 can implement various different methods to dispense the storage containers 302c-e. An exemplary local computing system is described in further detail with respect to FIG. 4.

FIG. 3C is a block diagram of the terminals 200, conveyer belt network 300 and kiosks 320 in accordance with an exemplary embodiment. As shown in FIG. 3C, multiple ones of the terminals 200 can be associated with each loading conveyor belt system 309. The conveyor carousel system 310 can include a main conveyor carousel system 310 and a second conveyer carousel system, e.g., conveyor carousel systems 310b-c. The main conveyor carousel system 310a can be operable coupled to the secondary conveyor carousel systems 310b-c by intermediate conveyor belt systems 318 and storage containers can be transferred from the main conveyor carousel system 310a to the secondary conveyor carousel systems 310b-c by diverters e.g., diverters 314a-c. Each of the loading conveyor belt systems 309a-c can transport storage containers to the main conveyor carousel system 310a. A position of the diverters 314a-c can maintain the storage containers on the conveyor main carousel system such that the storage containers are continuously transported around the main conveyor carousel system passed optical scanners 316a-c. Each optical scanner 316a-c can be associated with diverters 314a-c, respectively. The optical scanner 316a can be disposed in proximity to and upstream from diverter 314a (e.g., in a direction opposite the direction that the conveyor moves). The optical scanner 316b can be disposed in proximity to and upstream from diverter 314b. The optical scanner 316c can be disposed in proximity to and upstream from diverter 314c. When the optical scanner 316a scans a label on the storage container having an object identifier associated with one of the kiosks to which the diverter 314a routes storage containers, the position of the diverter can be changed to divert the storage container to the intermediate conveyor belt system 318a and subsequently the diverter 314a can return to its default position to prevent other storage containers from inadvertently being routed to the intermediate conveyor belt system 318a. By position the optical scanners 316a-c in proximity and upstream to their corresponding diverters 314a-c, the positon of the diverters 314a-c can be precisely controlled to ensure that the appropriate storage containers are routed to the appropriate intermediate conveyor belt systems 318.

In one example, a storage container can be loaded onto a loading conveyer belt 309a at terminal 200a. The loading conveyer belt system 309a can transport the storage container from the terminal to a conveyer carousel system 310a.

The conveyer carousel system 310a can transport the storage container in a circular direction towards and passed an optical scanner 316a. The optical scanner 316a can scan and read a machine-readable element disposed on a label the storage container. The machine-readable element can be encoded with an object identifier. The object identifier can be transmitted to a local computing system. A position of the diverter 316a can be controlled to rout the storage container to the intermediate conveyer belt 318a based on a determination that the storage container is destined for one of the kiosks downstream of the intermediate conveyor belt system 318a. The diverter 316a can be embodied as a mechanical arm that transfers the storage container from the conveyer carousel system 310a to the intermediate conveyer belt system 318a.

The intermediate conveyer belt system 318a can transport the storage container to a conveyer carousel system 310b. The conveyer carousel system 310b can transport the storage container in a circular direction passed the optical scanner 316d. The optical scanner 316d can scan and decode the identifier from the machine readable element on the label disposed on the storage container as the storage container passes the optical scanner 316a. The optical scanner 316d can transmit the identifier to the local computing system.

The local computing system can receive the object identifier and can also receive confirmation from a kiosk 320a that the storage container is destined for the kiosk 320a. If the kiosk is unable to receive the storage container (e.g., because it currently does not have the capacity to receive or store the storage container) the position of the diverter 314d remains unchanged and the storage container contuse around the conveyor carousel 310b. The storage container can continue to be transferred around the conveyor carousel system and passed the optical scanner 316a, and the optical scanner 316a can scan the label on the storage container each time it passes the optical scanner to trigger checking the availability of the kiosk 320a to receive the storage container. When, upon scanning the label on the storage container, the local system determines that the kiosk 320a is available to receive the storage container. at which time, the local computing system can control a position of the diverter 314d to route the storage container from the conveyer carousel system 310b to the intermediate conveyer belt system 318d. The intermediate conveyer belt 318d can be coupled to the kiosk 320a. The intermediate conveyer belt system 318d can transport the storage container to the kiosk 320a. The kiosk 320a can deposit the storage container.

In another example, a storage container can be loaded onto a loading conveyer belt 309b at terminal 200b. The loading conveyer belt system 309b can transport the storage container from the terminal to a conveyer carousel system 310a.

The conveyer carousel system 310a can transport the storage container in a circular direction towards and passed the optical scanner 316a. The optical scanner 316a can scan and decode the object identifier from the machine-readable element on the label disposed on the storage container. The object identifier can be transmitted to a local computing system and the local computing system can determine that the storage container is not associated with any of the kiosks downstream of the intermediate conveyor belt system 318a. As a result, a position of the diverter 314a remains unchanged and the storage container continues around the conveyor carousel system 310a.

As the storage container continues around the conveyer carousel system 310a, the storage container passes the optical scanner 316b. The optical scanner 316b can scan and decode the object identifier from the machine-readable element on the label disposed on the storage container. The object identifier can be transmitted to a local computing system and the local system can determine that the storage container is associated with any of the kiosks downstream of the intermediate conveyor belt system 318b. As a result, a position of the diverter 314b is changed by the local computing system and the storage container is diverted to route the storage container to an intermediate conveyer belt 318b.

The conveyer carousel system 310a can transport the storage container in a circular direction towards and passed the optical scanner 316g and 316h. The optical scanner 316g can scan and decode the object identifier from the machine-readable element on the label disposed on the storage container. The object identifier can be transmitted to a local computing system and the local computing system can determine that the storage container is not associated with any of the kiosks downstream of the intermediate conveyor belt system 318g and 318h. As a result, a position of the diverter 314g and 314h remains unchanged and the storage container continues around the conveyor carousel system 310c.

As the storage container continues around the conveyer carousel system 310c, the storage container passes the optical scanner 316i. The optical scanner 316i can scan and decode the object identifier from the machine-readable element on the label disposed on the storage container. The object identifier can be transmitted to a local computing system and the local system can determine that the storage container is associated with any of the kiosks downstream of the intermediate conveyor belt system 318i. As a result, a position of the diverter 314i is changed by the local computing system and the storage container is diverted to route the storage container to an intermediate conveyer belt 318i. The intermediate conveyer belt 318i can transport the storage container to the kiosk to 320f the kiosk can be deposited from kiosk 320f.

In another example, a storage container can be loaded onto a loading conveyer belt 309c at terminal 200c. The loading conveyer belt system 309c can transport the storage container from the terminal to a conveyer carousel system 310a.

The conveyer carousel system 310a can transport the storage container in a circular direction towards and passed an optical scanner 316b and 316c. The optical scanner 316b can scan and decode the object identifier from the machine-readable element on the label disposed on the storage container. The object identifier can be transmitted to a local computing system and the local computing system can determine that the storage container is not associated with any of the kiosks downstream of the intermediate conveyor belt system 318b and 318c. As a result, a position of the diverter 314b and 314c remains unchanged and the storage container continues around the conveyor carousel system 310a. The optical scanner 316a can scan and read a machine-readable element disposed on a label the storage container. The machine-readable element can be encoded with an object identifier. The object identifier can be transmitted to a local computing system. A position of the diverter 316a can be controlled to rout the storage container to the intermediate conveyer belt 318a based on a determination that the storage container is destined for one of the kiosks downstream of the intermediate conveyor belt system 318a. The diverter 316a can be embodied as a mechanical arm that transfers the storage container from the conveyer carousel system 310a to the intermediate conveyer belt system 318a.

The intermediate conveyer belt system 318a can transport the storage container to a conveyer carousel system 310b. The conveyer carousel system 310b can transport the storage container in a circular direction passed the optical scanner 316d. The optical scanner 316d can scan and decode the identifier from the machine readable element on the label disposed on the storage container as the storage container passes the optical scanner 316a. The optical scanner 316d can transmit the identifier to the local computing system.

The local computing system can receive the object identifier and can also receive confirmation from a kiosk 320a that the storage container is destined for the kiosk 320a. If the kiosk is unable to receive the storage container (e.g., because it currently does not have the capacity to receive or store the storage container) the position of the diverter 314d remains unchanged and the storage container contuse around the conveyor carousel 310b. The storage container can continue to be transferred around the conveyor carousel system and passed the optical scanner 316a, and the optical scanner 316a can scan the label on the storage container each time it passes the optical scanner to trigger checking the availability of the kiosk 320a to receive the storage container. When, upon scanning the label on the storage container, the local system determines that the kiosk 320a is available to receive the storage container. at which time, the local computing system can control a position of the diverter 314d to route the storage container from the conveyer carousel system 310b to the intermediate conveyer belt system 318d. The intermediate conveyer belt 318d can be coupled to the kiosk 320a. The intermediate conveyer belt system 318d can transport the storage container to the kiosk 320a. The kiosk 320a can deposit the storage container.

FIG. 4 is a block diagram illustrating an automated routing system according to exemplary embodiments of the present disclosure. The automated routing system 450 can include one or more databases 405, one or more servers 410, one or more local computing systems 400, one or more conveyer belt networks 300, one or more kiosks 320, one or more terminals 200 and one or more mobile devices 100. The mobile device 100 can include a facility application 132. The facility application 132 can be an executable residing on the mobile device 100. In exemplary embodiments, the local computing system 400 can be in communication with the databases 405, the server(s) 410, conveyer belt networks 300, kiosks 320, terminals 200 and mobile devices 100, via a communications network 415. The local computing system 400 can implement at least one instance of a control engine 420. The control engine 420 can be an executable residing on the local computing system 400, configured to implement the automated routing system 450.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The local computing system 400 includes one or more computers or processors configured to communicate with the conveyer belt networks 300, kiosks 320, terminals 200 and mobile devices 100, via a communications network 415. The local computing system 400 hosts one or more applications configured to interact with one or more local components computing system 400 and/or facilitates access to the content of the databases 405. In some embodiments, the server 410 can host the control engine 420 or portions thereof. The databases 405 may store information/data, as described herein. For example, the databases 205 can include mobile devices database 430, storage containers 435 and the kiosks database 440. The mobile devices database 430 can store information associated with mobile device. The storage container database 435 can store information associated with storage containers. The kiosks database 440 can store information associated with kiosks. The databases 405 and server 410 can be located at one or more geographically distributed locations from each other or from the computing system 400. Alternatively, the databases 405 can be included within server 410.

In one embodiment, physical objects can be placed in a storage container disposed with respect to a terminal 200. The terminal can transmit information associated with a storage container including physical objects to a local computing system 400. The local computing system 400 can execute the control engine 420 in response to receiving the information. The control engine 420 can generate an identifier associated with the storage container. The control engine 420 can generate a machine-readable element encoded with identifier. The control engine 420 can store the identifier associated with the storage container in the storage container database 435. The control engine 420 can instruct the terminal 200 to print a label including the machine-readable element. The terminal 200 can print the label, via the printer 206. The label can be affixed on the storage container.

In one embodiment, the labels can be static labels. The static label can include a machine-readable element encoded with an identifier. The terminal 200 can transmit the identifier to the local computing system 400. The control engine 420 can store the identifier in the storage containers database 435. The static labels can be re-used once the storage container is returned. In another embodiment, a new disposable label is created with a machine-readable element encoded with a new identifier.

The storage container can be placed on the loading conveyer belt system (e.g. loading conveyer belt 309 as shown in FIG. 3A) disposed with respect to the terminal 200 inside a facility. The loading conveyer belt system can transport the storage container to the conveyer carousel system (e.g. conveyer carousel system 310 as show in FIG. 3A). The storage container can be transferred from the loading conveyer belt system to the conveyer carousel system. The optical scanner 316 can be disposed with respect to the conveyer carousel system. The conveyer carousel system can transport the storage container towards the optical scanner 316. The optical scanner 316 can scan the machine-readable element on the label affixed to the storage container. The optical scanner 316 can decode the identifier from the machine-readable element and transmit the identifier to the local computing system 400.

The control engine 420 can query the storage containers database 435 to determine a location to which the storage container is to be transported, using the received identifier. The control engine 420 can query the kiosks database 440 to identify the kiosk 320 closest in proximity to the determined location. The control engine 420 can identify the intermediate conveyer belt system (e.g. intermediate conveyer belt system 318a-c as shown in FIG. 3A) coupled to the identified kiosk. The intermediate conveyer belt systems can be disposed inside and/or outside the facility and can be disposed above and/or underground. The kiosks 320 can be disposed outside the facility (i.e. a parking lot of the facility). The control engine 420 can transmit instructions to the diverter 314 to route the storage container from the conveyer carousel system to the identified intermediate conveyer belt system coupled to the identified kiosk. The storage container can be transferred to the identified one of the intermediate conveyer belt systems. The intermediate conveyer belt system can transport the storage container to the identified kiosk 320. The storage container enter the kiosk 320 from the intermediate conveyer belt system, from the back opening and the kiosk 320 can output the storage container through a front opening.

In one embodiment, a kiosk 320 can receive input associated with the storage container from one or more sources. The kiosk 320 can receive input via, the optical scanner 322 and/or the display 324. For example, a mobile device 100 can render a machine-readable element on the display of the mobile device 100, and the optical scanner 322 can scan and decode an identifier from the machine-readable element and transmit the identifier to the local computing system 400.

The identifier can be associated with a storage container. The storage container associated with the identifier can be traveling around the conveyer carousel belt system 309 waiting to be routed to a destination kiosk. The machine-readable element on the label of the storage container can be scanned by the optical scanner 316 as the storage container passes the optical scanner. The decoded identifier from the machine-readable element on the label can be transmitted to the local computing system 400. The control engine 420 can determine whether identifiers that have been input and/or received by any kiosk 320 correspond to the identifier scanned by the optical scanner 316. In the event the identifier has not been input and/or received by any kiosk 320, the diverters 314 of the carousel are set so that the storage container continues to travel around the conveyer carousel system. In the event, the control engine 420 determines the identifier has been input and/or received by a kiosk 320, the control engine 420 can identify the kiosk 320 as the destination and control a position of the corresponding diverter 314 to route the storage container to an intermediate conveyer belt system operatively coupled to the identified kiosk.

In one embodiment, the kiosk 320 can receive input automatically and/or wirelessly. For example, the kiosk 320 can detect a mobile device 100 in response to the mobile device 100 being within a specified distance of the kiosk 320 for more than a specified amount of time. The mobile device 100 can be executing a facility application 132. The kiosk 320 can extract the mobile identifier of the mobile device 100 and transmit the mobile identifier to the local computing system 400. The control engine 420 can query the mobile device database 430 to determine whether an identifier of a storage container is associated with the mobile device. In response to retrieving the identifier of the storage container, the control engine 420 can control a position of the diverter 314 to route the storage container to the intermediate conveyer belt system coupled to the kiosk 320. In some embodiments, a customer can input/request retrieval of the storage container at any kiosk 320 by entering identification information associated with the storage container at the display of the kiosk.

In one embodiment, the terminal 200 can receive input automatically and/or wirelessly. For example, the terminal 200 can receive input associated with the location associated with the storage container's destination. The terminal 200 can receive an identifier associated with a kiosk, GPS coordinates and/or a parking spot number. The terminal 200 can transmit the location information to the local computing system 200. The control engine 420 can identify the kiosk based on the received location information. In one embodiment, the terminal can receive input via the mobile device 100 executing the facility application 132. The facility application 132 can transmit a mobile identifier of the mobile device 100 to the terminal 200. The terminal 200 can transmit the mobile identifier to the local computing system 400. The control engine 420 can query the mobile devices 100 database using the identifier to determine a destination of the storage container. For example, a user of the mobile device 100 can input a location of their vehicle in the parking lot (i.e. parking spot number, GPS coordinates) in the facility application 132. Alternatively, the facility application 132 can determine the location of the mobile device. The facility application 132 can transmit the input and/or determine location to the local computing system 400. The control engine 420 can store the mobile identifier and the input and/or determined location in the mobile device database 430. The control engine 420 can retrieve the location in response to receiving the mobile identifier from the terminal.

As a non-limiting example, the automated routing system 240 can be implemented in a retail store and products can be disposed at the retail store. A customer shopping in a retail store can purchase products at the terminal 200 in the retail store and choose to have them delivered outside the retail store (i.e. the parking lot). The products can be placed in a storage container disposed with respect to the terminal 200. The terminal 200 can transmit information associated with a storage container including physical objects to the local computing system 400. The control engine 420 can instruct the terminal 200 to print a label including a machine-readable element encoded with an identifier associated with the storage container. The terminal 200 can print the label, via the printer 206. The label can be affixed on the storage container. The control engine 420 stores the identifier in the storage container database 435.

The storage container can be placed on the loading conveyer belt system 306 disposed with respect to the terminal 200 inside a facility. The loading conveyer belt system can transport the storage container to the conveyer carousel system. The storage container can be transferred from the loading conveyer belt system 306 to the conveyer carousel system 309. The optical scanner 316 can be disposed with respect to the conveyer carousel system 309. The conveyer carousel system 309 can transport the storage container passed the optical scanner 316. The optical scanner 316 can scan the machine-readable element on the label affixed to the storage container as the storage container passes the optical scanner 316. The optical scanner 316 can decode the identifier from the machine-readable element scanned by the optical scanner 316, and can transmit the identifier to the local computing system 400.

The control engine 420 can query the storage containers database 435 to determine a location to which destination the storage container is to be transported, using the received identifier. In one embodiment, the control engine 420 can query the kiosks database 440 to identify the kiosk 320 closest in proximity to the determined location. The control engine 420 can control a position of the diverter 314 to divert the storage container from the conveyer carousel system 309 to the identified intermediate conveyer belt system 318a-c operatively coupled to the identified kiosk. The intermediate conveyer belt system 318a-c can transport the storage container to the identified kiosk 320. The storage container enter the kiosk 320 from the intermediate conveyer belt system 318a-c, from the back opening and the kiosk 320 can output the storage container through a front opening.

A customer can retrieve the storage container at a kiosk 320 by manually or wirelessly inputting information at the kiosk 320. For example, in one embodiment, a customer can complete a transaction of purchasing products at a terminal 200. The products can be placed in a storage container. The storage container can include a label with a machine-readable element encoded with an identifier. In response to completing the transaction, the control engine 420 can transmit a machine-readable element encoded with an identifier associated with the storage container, to a facility application 132 executing on the mobile device 100. A customer can retrieve the storage container at the kiosk 320. The mobile device 100 can render a machine-readable element on the display of the mobile device 100. The optical scanner 322 can scan and decode the identifier from the machine readable element and transmit the identifier to the local computing system 400. In some embodiments, the customer can manually enter the identifier at the kiosk 320 (using a keypad or display).

The machine-readable element can be encoded with the identifier of the storage container. The control engine 420 can identify the kiosk 320 as the destination and control a position of the diverter 314 to route the storage container to an intermediate conveyer belt system 318a-c coupled to the identified kiosk 320.

In another example, the terminal 200 can receive input automatically and/or wirelessly. For example, the terminal 200 can receive input associated with the location which is associated with the storage container's destination. The customer can input the location at the terminal 200. The terminal 200 can receive an identifier associated with a kiosk, GPS coordinates and/or a parking spot number. The terminal 200 can transmit the location information to the local computing system 200. The control engine 420 can identify the kiosk based on the received location information. In one embodiment, the terminal can receive input via the mobile device 100 executing the facility application 132. The facility application 132 can transmit a mobile identifier of the mobile device 100 to the terminal 200. The terminal 200 can transmit the mobile identifier to the local computing system 400. The control engine 420 can query the mobile devices 100 database using the identifier to determine a destination of the storage container. For example, a user of the mobile device 100 can input a location of their vehicle in the parking lot (i.e. parking spot number, GPS coordinates) in the facility application 132. Alternatively, the facility application 132 can determine the location of the mobile device. The facility application 132 can transmit the input and/or determine location to the local computing system 400. The control engine 420 can store the mobile identifier and the input and/or determined location in the mobile device database 430. The control engine 420 can retrieve the location in response to receiving the mobile identifier from the terminal.

In another example, the mobile device 100 can indicate its location outside the facility for retrieval of the storage container. For example, execute the facility application 132. The facility application 132 can determine the mobile device 100 is within a specified distance of the of the retail store based on the location of the mobile device 100. The facility application 132 can transmit a mobile identifier and the location of the mobile device 100 when the mobile device 100 is within the specified distance of the facility. The facility application 132 can determine a location of where a customer has parked in the parking lot. The control engine 420 can store the mobile identifier and location of the mobile device 100 in the mobile device database 430.

A storage container containing physical objects can be placed on the conveyer belt network 300. The facility application 132 can transmit the mobile identifier of the mobile device 100 to the local computing system 400 after the completion of the transaction at the terminal 200. The control engine 420 can query the mobile device database 430 to retrieve the location where the customer parked their vehicle. The control engine 420 can query the kiosks database 440 to identify the closest kiosk 320 to the determined location. The control engine 420 can instruct the diverter 314 to route the storage container to the intermediate conveyer belt 318a-c coupled to the identified kiosk 320.

In another example, the local computing system can receive input associated with the location of the mobile device from an image capturing device (not shown). For example, an image capturing device can be disposed in the parking lot of the retail store. The image capturing device can capture an image of the customer locations location in the parking lot. The image can be transmitted to the local computing system 400. The control engine 420 can extract image attributes using image analysis and/or video analytics. The control engine 420 can determine the location of the customer based on the extracted image attributes. The control engine 420 can query the kiosks database 440 to determine the kiosk closest to the determined location.

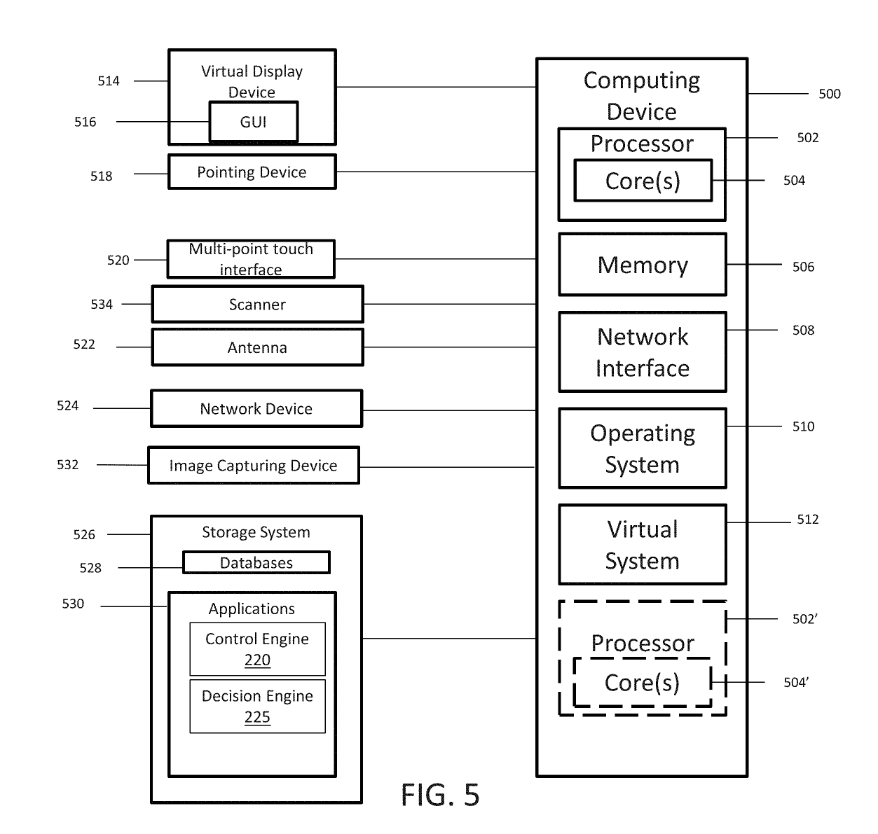

FIG. 5 is a block diagram of an exemplary computing device suitable for implementing embodiments of the automated routing system. The computing device may be, but is not limited to, a smartphone, laptop, tablet, desktop computer, server or network appliance. The computing device 500 can be embodied as part of the local computing system and/or terminal. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530 such as the control engine 420) for implementing exemplary operations of the computing device 500. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. The computing device 500 can receive data from input/output devices such as, a reader 534 and an image capturing device 532.

A user may interact with the computing device 500 through a visual display device 514, such as a computer monitor, which may display one or more graphical user interfaces 516, multi touch interface 520 and a pointing device 518.

The computing device 500 may also include one or more storage devices 526, such as a hard-drive, CD-ROM, or other computer readable media, for storing data and computer-readable instructions and/or software that implement exemplary embodiments of the present disclosure (e.g., applications 530 such as the control engine 420). For example, exemplary storage device 526 can include one or more databases 528 for storing information such as information associated with storage containers, kiosks and mobile devices. The databases 528 may be updated manually or automatically at any suitable time to add, delete, and/or update one or more data items in the databases.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

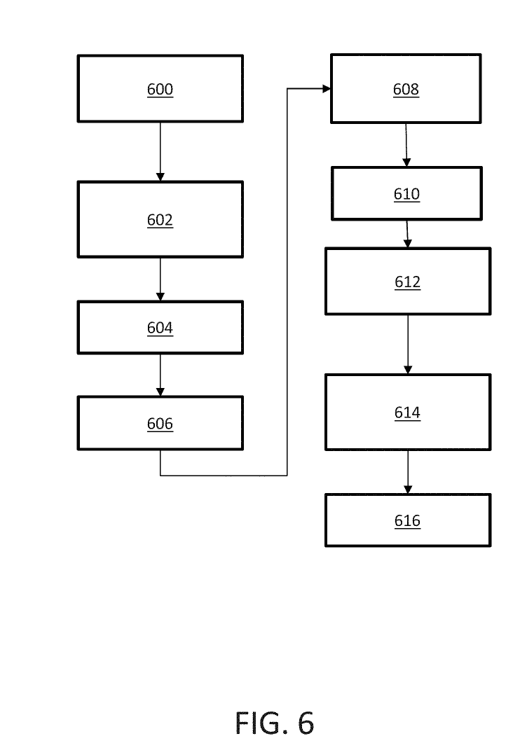

FIG. 6 is a flowchart illustrating the process for the automated routing system according to exemplary embodiments of the present disclosure. In operation 600, a first conveyer belt system (e.g. loading conveyer belt system 306 as shown in FIGS. 3A and 4) can receive and transport storage containers (e.g. storage containers 302a-e as shown in FIGS. 3A-B). The loading conveyer belt system can be disposed with respect to an electronic terminal (e.g. terminal 200 as shown in FIG. 2) in a facility. A label including an object machine-readable element (machine-readable element 304 as shown in FIG. 3A) encoded with an object identifier, is disposed on each of the storage containers.

In operation 602, the conveyer carousel system (e.g. conveyer carousel system 309 as shown in FIGS. 3A and 4) operatively coupled to the first conveyer belt system can receive the storage containers from the first conveyer belt system. In operation 604, the conveyer carousel system can transport the storage containers passed a first scanner (e.g. optical scanner 316 as shown in FIGS. 3A and 4). In operation 606, a diverter (e.g. diverter 314 as shown in FIGS. 3A and 4) can be positioned to guide the storage containers to remain on the conveyer carousel system or route each storage container one of a geographically distributed kiosks (e.g. kiosks 320 as shown in FIGS. 3B and 4) external to the facility based on the object machine-readable element on the label of each of the plurality of storage containers that is scanned by the first scanner as the storage containers pass by the first scanner.

In operation 608, the geographically distributed kiosk can receive input from a user. The input can be an identifier associated with the label of a specified one of the storage containers, or a parking spot number/area. In operation 610, the input can be transmitted to the local computing system. In operation 612, the local computing system can identify the kiosk and the specified storage container based on the input received by the kiosk. In operation 614, the local computing system can control a position of the diverter to route the specified storage containers from the conveyer carousel system to the identified kiosks in response to receipt of the identifier. In operation 616, the specified one of the storage containers can be transported to the geographically distributed kiosk via an intermediate conveyer belt system (e.g. intermediate conveyer belt system 318a-c as shown in FIGS. 3A-B and 4) coupled to the geographically distributed kiosk.

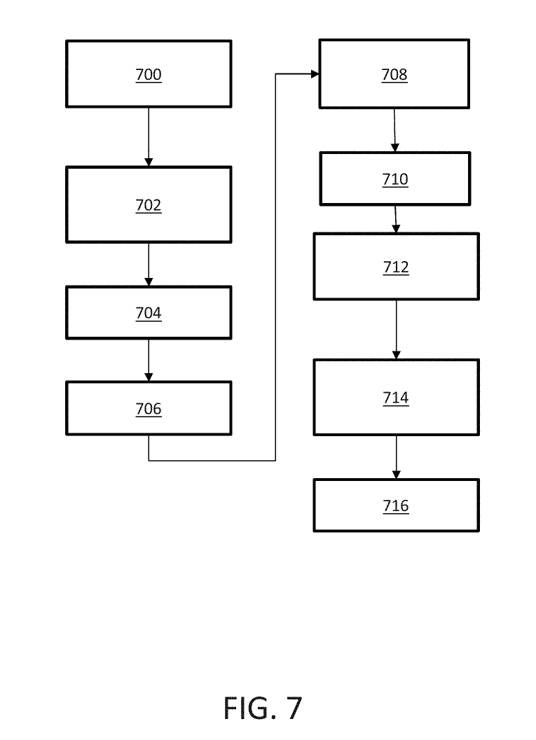

FIG. 7 is a flowchart illustrating the process for the automated routing system according to exemplary embodiments of the present disclosure. In operation 700, a first conveyer belt system (e.g. loading conveyer belt system 306 as shown in FIGS. 3A and 4) can receive and transport storage containers (e.g. storage containers 302a-e as shown in FIGS. 3A-B). The loading conveyer belt system can be disposed with respect to an electronic terminal (e.g. terminal 200 as shown in FIG. 2) in a facility. A label including an object machine-readable element (machine-readable element 304 as shown in FIG. 3A) encoded with an object identifier, is disposed on each of the storage containers.

In operation 702, the conveyer carousel system (e.g. conveyer carousel system 309 as shown in FIGS. 3A and 4) operatively coupled to the first conveyer belt system can receive the storage containers from the first conveyer belt system. In operation 704, the conveyer carousel system can transport the storage containers passed a first scanner (e.g. optical scanner 316 as shown in FIGS. 3A and 4). In operation 706, a diverter (e.g. diverter 314 as shown in FIGS. 3A and 4) can be positioned to guide the storage containers to remain on the conveyer carousel system or route each storage container one of a geographically distributed kiosks (e.g. kiosks 320 as shown in FIGS. 3B and 4) external to the facility based on the object machine-readable element on the label of each of the plurality of storage containers that is scanned by the first scanner as the storage containers pass by the first scanner.

In operation 708, the geographically distributed kiosk can receive input from a mobile device (e.g. mobile device 100 as shown in FIG. 1). The input can be GPS coordinates indicating the location of the mobile device. The kiosk can detect the GPS coordinates based on the mobile device being in specified proximity of the kiosk. In operation 710, the input can be transmitted to the local computing system. In operation 712, the local computing system can identify the kiosk and the specified storage container based on the input received by the kiosk. In operation 714, the local computing system can control a position of the diverter to route the specified storage containers from the conveyer carousel system to the identified kiosks in response to receipt of the identifier from an optical scanner associated with the diverter, where the optical scanner scans the label on the storage container as it passes by on the conveyor carousel system as described herein. In operation 716, the specified one of the storage containers can be transported to the geographically distributed kiosk via an intermediate conveyer belt system (e.g. intermediate conveyer belt system 318a-c as shown in FIGS. 3A-B and 4) coupled to the geographically distributed kiosk.

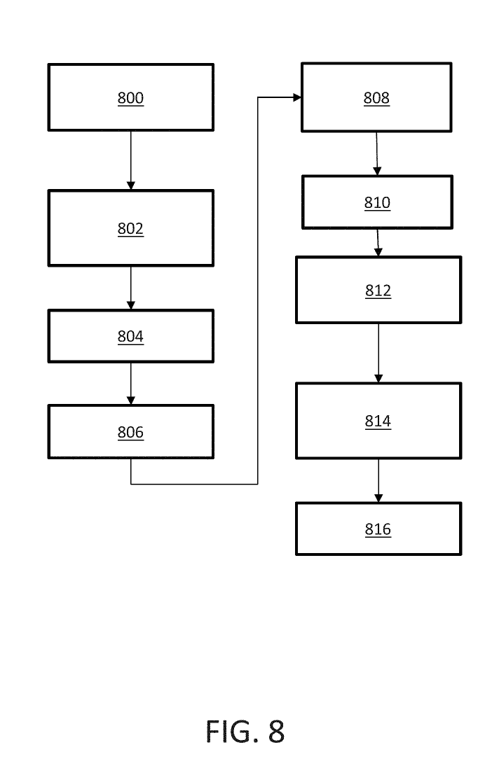

FIG. 8 is a flowchart illustrating the process for the automated routing system according to exemplary embodiments of the present disclosure. In operation 800, a first conveyer belt system (e.g. loading conveyer belt system 306 as shown in FIGS. 3A and 4) can receive and transport storage containers (e.g. storage containers 302a-e as shown in FIGS. 3A-B). The loading conveyer belt system can be disposed with respect to an electronic terminal (e.g. terminal 200 as shown in FIG. 2) in a facility. A label including an object machine-readable element (machine-readable element 304 as shown in FIG. 3A) encoded with an object identifier, is disposed on each of the storage containers.

In operation 802, the conveyer carousel system (e.g. conveyer carousel system 309 as shown in FIGS. 3A and 4) operatively coupled to the first conveyer belt system can receive the storage containers from the first conveyer belt system. In operation 804, the conveyer carousel system can transport the storage containers passed a first scanner (e.g. optical scanner 316 as shown in FIGS. 3A and 4). In operation 806, a diverter (e.g. diverter 314 as shown in FIGS. 3A and 4) can be positioned to guide the storage containers to remain on the conveyer carousel system or route each storage container one of a geographically distributed kiosks (e.g. kiosks 320 as shown in FIGS. 3B and 4) external to the facility based on the object machine-readable element on the label of each of the plurality of storage containers that is scanned by the first scanner as the storage containers pass by the first scanner.

In operation 808, the geographically distributed kiosk can scan and decode an identifier from a machine-readable element displayed on a display by the mobile device (e.g. mobile device 100 as shown in FIG. 1), via an optical scanner (e.g. optical scanner 322 as shown in FIG. 3B). In operation 810, the identifier can be transmitted to the local computing system. In operation 812, the local computing system can identify the kiosk and the specified storage container based on the identifier received by the kiosk. In operation 814, the local computing system can control a position of the diverter to route the specified storage containers from the conveyer carousel system to the identified kiosks in response to receipt of the identifier. In operation 816, the specified one of the storage container can be transported to the geographically distributed kiosk via an intermediate conveyer belt system (e.g. intermediate conveyer belt system 318a-c as shown in FIGS. 3A-B and 4) coupled to the geographically distributed kiosk

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An autonomous object routing system comprising:
a first conveyer belt system disposed with respect to an electronic terminal in a facility, the first conveyer belt system configured to receive and transport a plurality of storage containers, wherein a label including an object machine-readable element encoded with an object identifier is disposed on each of the plurality of storage containers;
a conveyer carousel system coupled to the first conveyer belt system, the first conveyer carousel system configured to:
receive the plurality of storage containers from the first conveyer belt, and
transport the plurality of storage containers passed the first scanner; and
at least one diverter for guiding the plurality of storage containers to remain on the conveyer carousel system or route each storage container to one of a plurality of geographically distributed kiosks external to the facility based on the object machine-readable element on the label of each of the plurality of storage containers that is scanned by the first scanner as the plurality of storage containers pass by the first scanner;
at least one of the plurality of geographically distributed kiosks being configured to:
receive an identifier associated with the label of a specified one of the plurality of storage containers,
control the diverter to route the specified one of the plurality of storage containers from the conveyer carousel system to the at least one of the plurality of geographically distributed kiosks in response to receipt of the identifier.

2. The system of claim 1, further comprising a second scanner coupled to the at least one kiosk, the second scanner configured to scan and decode the identifier from the machine-readable element.

3. The system of claim 1, further comprising a mobile device programmed to execute an application associated with the facility.

4. The system of claim 3, wherein the at least one kiosk is configured to receive the identifier from the mobile device in response to the mobile device executing the application and being in proximity of the at least one kiosk for a specified amount of time.

5. The system of claim 1, further comprising a local computing system including a database, the local computing system being in communication with the at least one diverter, the first scanner, and the plurality of geographically distributed kiosks.

6. The system of claim 5, wherein the first scanner is configured to:
scan and decode the object identifier from the object machine-readable element on the label of the at least one storage container; and
transmit the object identifier to the local computing system.

7. The system of claim 6, wherein the at least one of the plurality of geographically distributed kiosks is configured to transmit the identifier to the local computing system.

8. The system of claim 7, wherein the local computing system is configured to:
receive the object identifier and the identifier;
determine the identifier is associated with the object identifier; and
actuate the diverter to route the specified one of the plurality of storage containers to the at least one of the plurality of geographically distributed kiosks in response to determining the identifier is associated with the object identifier.

9. An autonomous routing system comprising:
a terminal including a printer and disposed in a facility configured to:
receive information associated with a location outside the facility;
identify at least one kiosk of a plurality of geographically distributed kiosks disposed outside the facility based on the information associated with the location;
generate an object machine-readable element encoded with an object identifier associated with the at least one kiosk; and
print, using the printer, a label including the object machine-readable element,
wherein the label is placed on at least one storage container;
a loading conveyer belt system coupled to a first scanner and a set of intermediate conveyer belt systems disposed with respect to the terminal configured to:
receive the at least one storage container;
transport the at least one storage container to the first scanner;
route the at least one storage container to at least one intermediate conveyer belt system from the set of conveyer belt systems in response to the scanner scanning the object machine-readable element on the label disposed on the at least one storage container;
wherein the at least one kiosk of a plurality of geographically distributed kiosks disposed outside the facility and coupled to the at least one intermediate conveyer belts, the at least one kiosk configured to:
receive an identifier associated with the label of a specified one of the plurality of storage containers,
control the diverter to route the specified one of the plurality of storage containers from the conveyer carousel system to the at least one of the plurality of geographically distributed kiosks in response to receipt of the identifier

10. The system of claim 9, wherein the information can include one or more of: input at the terminal, attributes of a captured image, GPS coordinates, or location information.

11. The system of claim 9, further comprising a second scanner coupled to the at least one kiosk, the second scanner configured to scan and decode the identifier from a machine-readable element.

12. The system of claim 9, further comprising a mobile device programmed to execute an application associated with the facility.

13. The system of claim 12, wherein the at least one kiosk is configured to receive the identifier from the mobile device in response to the mobile device executing the application and being in proximity to the at least one kiosk for a specified amount of time.

14. The system of claim 1, further comprising a local computing system including a database, the local computing system being in communication with the loading conveyer belt system, the first scanner, and the kiosk.

15. The system of claim 14, wherein the first scanner is configured to:
scan and decode an object identifier from the object machine-readable element on the label of the at least one storage container; and
transmit the object identifier to the local computing system.

16. The system of claim 15, wherein the at least one kiosk is configured to transmit the identifier to the local computing system.

17. The system of claim 16, wherein the local computing system is configured to:
receive the object identifier and the identifier;
determine the identifier is associated with the object identifier; and
control the operation of the loading conveyer belt system to route the at least one storage container to the at least one intermediate conveyer belts, in response to determining the identifier is associated with the object identifier.

18. An autonomous object routing method comprising:
receiving and transporting, via a first conveyer belt system disposed with respect to an electronic terminal in a facility, a plurality of storage containers, wherein a label including an object machine-readable element encoded with an object identifier, is disposed on each of the plurality of storage containers;
receiving, via a conveyer carousel system coupled to the first conveyer belt system, the plurality of storage containers from the first conveyer belt system;
transporting, via the conveyer carousel system, the plurality of storage containers passed a first scanner;
guiding, via at least one diverter, the plurality of storage containers to remain on the conveyer carousel system or route each storage container to one of a plurality of geographically distributed kiosks external to the facility based on the object machine-readable element on the label of each of the plurality of storage containers that is scanned by the first scanner as the plurality of storage containers pass by the first scanner;
receiving, via at least one of the plurality of geographically distributed kiosks, an identifier associated with the label of a specified one of the plurality of storage containers;
controlling, via the at least one geographically distributed kiosks, the diverter to route the specified one of the plurality of storage containers from the conveyer carousel system to the at least one of the plurality of geographically distributed kiosks in response to receipt of the identifier.

19. The method of claim 18, further comprising:
scanning and decoding, via the first scanner, an object identifier from the object machine-readable element on the label of the at least one storage container; and
transmitting, via the first scanner, the object identifier to a local computing system.

20. The method of claim 19, transmitting, via the at least one of the plurality of geographically distributed kiosks, the identifier to the local computing system.

21. The method of claim 20, further comprising:
receiving, via the local computing system including a database and in communication with the at least one diverter, the first scanner, and the plurality of geographically distributed kiosks, the object identifier and the identifier;
determining, via the local computing system, the identifier is associated with the object identifier; and
actuating, via the local computing system, the diverter to route the specified one of the plurality of storage containers to the at least one of the plurality of geographically distributed kiosks in response to determining the identifier is associated with the object identifier.
